(19) United States
(12) Patent Application Publication
(10) Pub. No.: US 2008/0159280 A1
(43) Pub. Date: Jul. 3, 2008

(54) EVENT HANDLING WITHIN MULTI-MODAL SHORT RANGE WIRELESS NETWORKS

(75) Inventors: Lih-Tyng Hwang, Crystal Lake, IL (US); Liliana Grajales, Bloomingdale, IL (US); Irfan Nasir, Lake In The Hills, IL (US); Aroon V. Tungare, Winfield, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/617,781

(22) Filed: Dec. 29, 2006

(51) Int. Cl. H04L 12/56

(52) U.S. Cl. 370/389

(57) ABSTRACT

A method, apparatus, and electronic device for achieving simultaneous communication between multiple protocols are disclosed. The method may include receiving with a telecommunication device a first message on a first communications network using a first communications protocol; simultaneously receiving with the telecommunication device a second message on a second communications network using a second communications protocol; assigning a first priority to the first message; assigning a second priority to the second message; and processing the first message and the second message in an order based on the first priority and the second priority.

### FIELD OF THE INVENTION

The present invention relates to a method and system for managing multiple communication protocols in a mobile communication device. The present invention further relates to achieving simultaneous communication over multiple protocols to remotely manage a sensor network.

### INTRODUCTION

When a mobile communications device connects to a telecommunications network, the device may follow a series of standard rules called a communications protocol. These rules may cover data representation, signaling, authentication, and error detection. These protocols allow for more efficient and faster communications.

One such protocol is WiFi®. WiFi® is a protocol developed by working group 11 of the Institute of Electrical and Electronics Engineers (IEEE) Local Area Network (LAN)/Metropolitan Area Network (MAN) Standards Committee. WiFi® was developed to be used with mobile computing devices. WiFi® is commonly used in homes, commercial shops, and even within municipals to create a wireless LAN (WLAN). A WiFi® access point may broadcast its service set identifier (SSID) via beacon packets. A user may choose to connect to an access point based on that SSID. The connections may be encrypted using various kinds of password protection.

Another protocol is ZigbBee. ZigBee® is a protocol developed by working group 15 of the IEEE 802. ZigBee® was developed to be used with wireless personal area network (WPAN) standards. ZigBee® operates on the industrial, scientific, and medical band. ZigBee® is considered to be a less expensive and a more power efficient alternative to other WPAN protocols, such as Bluetooth.

ZigBee® and WiFi® are eached used for different tasks. ZigBee® tends to be used more for monitoring and control functions, whereas WiFi® is used for various communications functions such as web transmissions, email, voice over internet protocol (VOIP), and video transmissions. A mobile communications device may have need to perform functions that require both types of protocols.

### SUMMARY OF THE INVENTION

A method, apparatus, and electronic device for achieving simultaneous communication between multiple protocols are disclosed. The method may include receiving with a telecommunication device a first message on a first communications network using a first communications protocol; simultaneously receiving with the telecommunication device a second message on a second communications network using a second communications protocol; assigning a first priority to the first message; assigning a second priority to the second message; and processing the first message and the second message in an order based on the first priority and the second priority.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a possible configuration of a computer system to act as a mobile system or base station to execute the present invention.

FIG. 2 illustrates in a block diagram the layers of the combined protocol telecommunication device.

FIG. 3 illustrates the spectrum use by both the first and second protocol in the present invention.

FIG. 4 illustrates the use of the combined protocol telecommunications device in conjunction with a sensor network.

FIG. 5 illustrates in a flowchart one embodiment of a method for handling messages from multiple protocols.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A combined protocol telecommunications device for achieving simultaneous communication between multiple protocols is disclosed. The method may include a telecommunication device that receives a first message on a first communications network using a first communications protocol. The telecommunication device simultaneously receives a second message on a second communications network using a second communications protocol. The telecommunications device assigns a first priority to the first message and a second priority to the second message. The telecommunication device processes the first message and the second message in an order based on the first priority and the second priority.

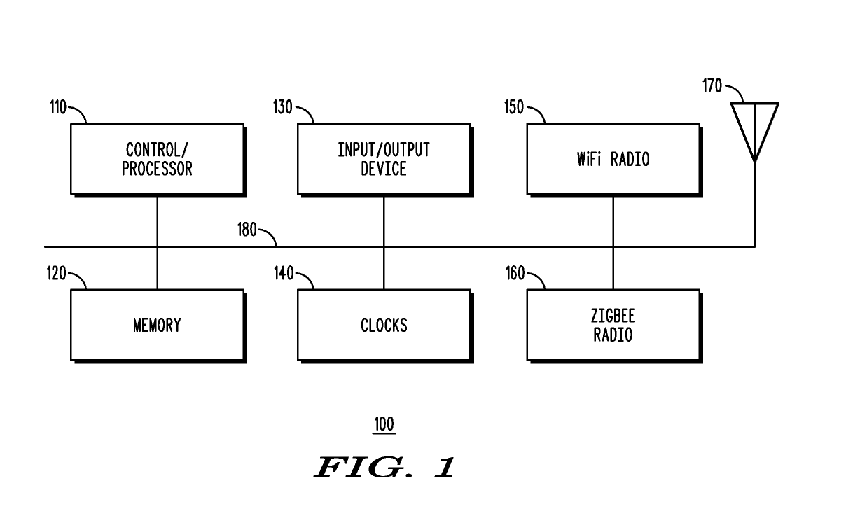

FIG. 1 illustrates a possible configuration of a computer system 100 to act as a mobile system or base station to execute the present invention. The computer system 100 may include a controller/processor 110, a memory 120 with a cache, an input/output device interface 130, a set of one or more use clocks 140, a radio to generate a connection using a first telecommunications protocol 150, a radio to generate a connection using a second telecommunications protocol 160, and an antenna 170, connected through a bus 180. The antenna 170 may comprise hardware and software needed to realize wireless links instructed by the embedded programs. The computer system 100 may implement any operating system, such as Windows or UNIX, for example. Client and server software may be written in any programming language, such as ABAP, C, C++, Java or Visual Basic, for example. The computer system 100 may be implemented as a system on a chip (SoC) with embedded programs.

The controller/processor 110 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 120 may include volatile and nonvolatile data storage, including one or more electrical, magnetic or optical memories such as a RAM, cache, hard drive, CD-ROM drive, tape drive or removable storage disk. The memory 120 may have a cache to speed access to specific data.

The Input/Output interface 130 may be connected to one or more input devices that may include a keyboard, mouse, pen-operated touch screen or monitor, voice-recognition device, or any other device that accepts input. The Input/Output interface 130 may also be connected to one or more output devices, such as a monitor, printer, disk drive, speakers, or any other device provided to output data.

The series of one or more timers 140 may include any clock, crystal, or timing device. A clock may produce a periodic signal that may be used for computing purposes, such as decoding or demodulating a signal sent over a frequency. A timing device may include any device used to measure the passage of time or to measure the frequency, duration, or period of any periodic signal.

While this embodiment discloses a first radio 150 to generate a first connection using a first telecommunications signal and a second radio 160 to generate a second connection using a second telecommunications signal are described, it is to be understood that a single radio generating both connections is also covered by this description. The first and second connection may use protocols such as ZigBee®, WiFi®, or other protocols. ZigBee® and WiFi® both use direct sequence spread spectrum (DSSS), which may allow for the consolidation of certain functions and devices. Both the first radio 150 and the second radio 160 may use the antenna 170, along with the necessary hardware, in order to create a telecommunication connection with another wireless device, according to the instructions given by the embedded programs.

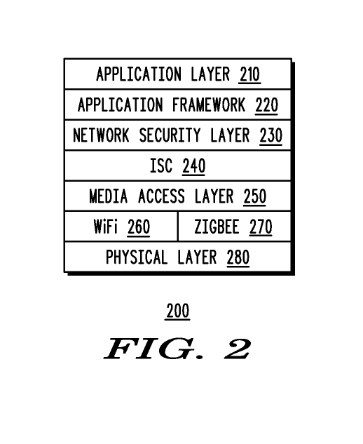

FIG. 2 illustrates in a block diagram the layers 200 of the combined protocol telecommunication device 100. The application layer 210 may include the client application being run by the user, such as a web browser or other software application that requires a connection with a communications network. The applications framework 220 may connect the client application to the networking layer 230 of the telecommunications device 100. The applications framework 220 may transparently transfer data between the application layer 210 and the network layer 220, providing error recovery and flow control. The network security layer 230 may provide a secure connection to the network. The network security layer may provide source to destination transfer of data packets. The intelligent system coordinator (ISC) intelligence 240 determines which protocol is being used to connect to the telecommunications device 100 to the network. The media access control (MAC) layer 250 may provide addressing and channel accessing control mechanisms to communicate within a network. The MAC layer 250 may enact the necessary protocol to provide the connection from node to node in the network. For example, a WiFi® protocol 260 or a Zigbee® protocol 270 may be used. WiFi® protocol 260 may use complementary code keying (CCK) as a coding technique. ZigBee® protocol 270 may use quadrature phase-shift keying (QPSK) as a coding technique. The physical (PHY) layer 280 may provide the base level data transmission of a network. The general PHY layer 280 may include more than one specific PHY layer 280 parameters to control the transmissions. For a telecommunications device using WiFi® and ZigBee®, a single type of physical layer may accommodate both protocols, as both use DSSS. Both protocols may operate at 2.45 GHz.

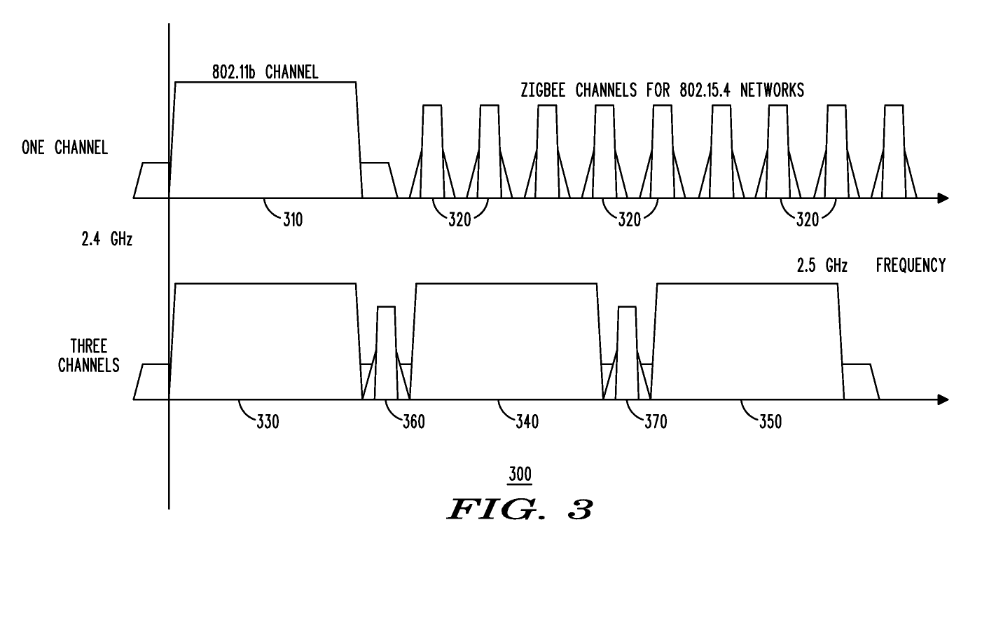

FIG. 3 illustrates the spectrum use 300 by both the first and second protocol in the present invention. In this example, the first protocol is WiFi® 310 and the second protocol is ZigBee® 320. The bigger bandwidth is WiFi® 310. ZigBee® 320 uses a narrower spectrum. Each protocol generally uses one channel at a time. The transmission may be pre-designed so that the protocols do not overlap. For example, a first channel 330, a second channel 340, and a third channel 350 may be available for WiFi® and a first channel 360 and a second channel 370 may be available for ZigBee®. If the first WiFi® channel 330 is being used, then the second ZigBee® channel 370 may be selected, or if the third WiFi® channel 350 is being used, then the first ZigBee® channel 360 may be selected. The ISC 240 may place a ZigBee® transmission between the WiFi® channel envelop to reduce interference and more efficiently use the different power levels of the spectra used by WiFi® and ZigBee®.

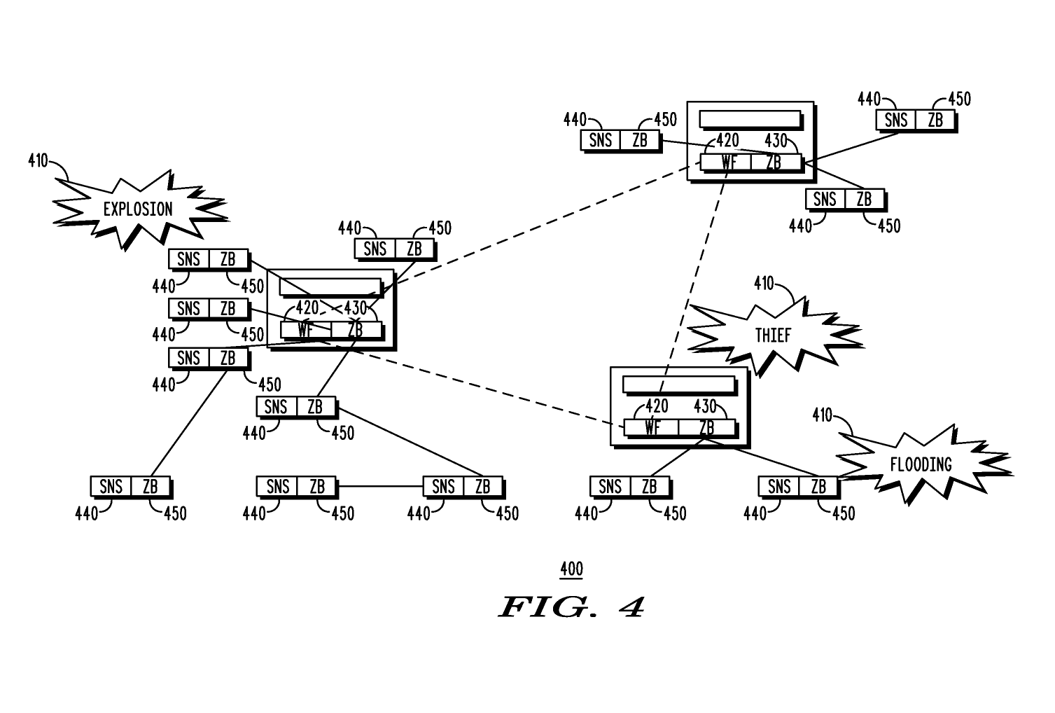

FIG. 4 illustrates the use of the combined protocol telecommunications device 100 in conjunction with a sensor network 400. The sensor network 400 may be used to alert the combined protocol telecommunications device 100 to events 410 that occur within the sensor network 400. The device 100 may be using WiFi® protocol 420 to perform its ordinary communications functions. The device 100 may contact the sensor network 400 over the ZigBee® protocol 430 network. If an event 410 occurs within the sensor network 400, a sensor 440 near the event may alert the combined protocol telecommunications device 100 via the sensors' 440 ZigBee® protocol communications device 450. The ISC 240 may receive notice of the event and respond. A response may be sent remotely to any necessary devices near the event over the WiFi® protocol 420 network. The ISC 240 may also be used for harmonious events as well as simultaneous events, where harmonious is an antonym of simultaneous. In one embodiment of a system monitoring harmonious events, the sensor network 400 may collect data on scheduled events. For example, a utility company using the sensor network 400 may use WiFi® protocol 420 to remotely obtain meter data from a sensor 440.

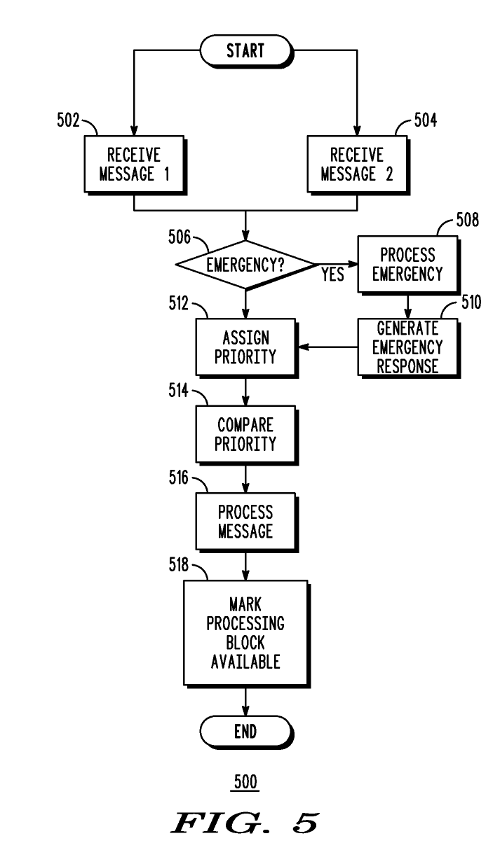

FIG. 5 illustrates in a flowchart one embodiment of a method 500 for handling messages from multiple protocols. The overall system 100 may behave as if simultaneous harmonious use of WiFi® and ZigBee® protocols is occurring. The combined protocol device 100 may receive a first message from a first network using a first protocol (Block 502) simultaneous with receiving a second message from a second network using a second protocol (Block 504).

If a message is marked as an emergency event (Block 506), the message containing the emergency event is processed immediately (Block 508) and the ISC 240 generates an emergency response to be transmitted to the appropriate devices (Block 510). Emergency events may be malfunctions in network devices or, in a sensor network, evidence of some event in a region that requires a response, such as security intrusion, flood, fire, or other events. The message may be marked as containing an emergency event by the remote sensor, the ISC 240 may make that determination upon a cursory initial review of the message, or some alternate device may make that determination. The response may be a notification to a responsible individual, a directive to a remote device on location (such as turning on the sprinklers or triggering a burglar alarm), or any other appropriate response based on the emergency presented.

If no emergency is present (Block 506), the ISC 240 may assign the messages a priority (Block 512). These priorities may be based on the location the message is received from, the time received, the nature of the message (such as an ordinary status report), the sensor data type, priority level, destination of the message, data threshold, data packaging, or other criteria. The ISC 240 may then compare the priorities (Block 514) and then send the messages to the application 210 for processing in an order based on their priorities (Block 516). After the application 210 has processed the messages using a processing block of the processor 110, the application 210 may mark the processing block as available for reuse in processing the next message (Block 518). The processing block is not limited to use in processing messages of one type of protocol, but rather may be used for many different types of protocol.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. It does not necessarily need to be one system used by all end users. Accordingly, the appended claims and their legal equivalents should only define the invention, rather than any specific examples given.

We claim:

1. A method for achieving simultaneous communication between multiple protocols, comprising:
receiving with a telecommunication device a first message on a first communications network using a first communications protocol;
simultaneously receiving with the telecommunication device a second message on a second communications network using a second communications protocol;
assigning a first priority to the first message;
assigning a second priority to the second message; and
processing the first message and the second message in an order based on the first priority and the second priority.

2. The method of claim 1, wherein the first telecommunication network includes a sensor network.

3. The method of claim 2, further comprising:
recognizing in the first message an indication of an emergency event at a sensor of the sensor network;
assigning an emergency priority to the first message; and
processing the first message on an emergency basis.

4. The method of claim 3, further comprising:
generating an emergency response to the first message; and
transmitting the emergency response on the second communications network.

5. The method of claim 1, wherein the first communication protocol and the second communication protocol are direct-sequence spread spectrum.

6. The method of claim 1, wherein the first communication protocol is ZigBee® and the second communication protocol is WiFi®.

7. The method of claim 1, wherein communication of the first communication network occurs between a channel envelop of the second communications network to reduce interference.

8. The method of claim 1, further comprising:
processing the first message using a first processing block;
receiving with the telecommunication device a third message on the second communications network using the second communications protocol; and
processing the third message using the first processing block.

9. The method of claim 1, further comprising:
receiving with the telecommunication device a third message on the second communications network representing a scheduled event; and
processing the third message harmoniously with the first message.

10. The method of claim 1, further comprising basing the first priority on at least one of a group consisting of location of the first message, timing, nature of the first message, data type, priority level, destination of the first message, data threshold, or data packaging.

11. A mobile telecommunications apparatus with simultaneous communication between multiple protocols, comprising:
a receiver that receives a first message on a first communications network using a first communications protocol and simultaneously receives a second message on a second communications network using a second communications protocol; and
a processor that assigns a first priority to the first message and a second priority to the second message, and processes the first message and the second message in an order based on the first priority and the second priority.

12. The mobile telecommunications apparatus of claim 11, wherein the first telecommunication network includes a sensor network.

13. The mobile telecommunications apparatus of claim 12, wherein the processor recognizes in the first message an indication of an emergency event at a sensor of the sensor network, assigns an emergency priority to the first message, and processes the first message on an emergency basis.

14. The mobile telecommunications apparatus of claim 13, further comprising:
a transmitter that transmits on the second communications network an emergency response based on the first message.

15. The mobile telecommunications apparatus of claim 11, wherein communication of the first communication network occurs between a channel envelop of the second communications network to reduce interference.

16. An electronic device with simultaneous communication between multiple protocols, comprising:
a receiver that receives a first message on a first communications network using a first communications protocol and simultaneously receives a second message on a second communications network using a second communications protocol; and
a processor that assigns a first priority to the first message and a second priority to the second message, and processes the first message and the second message in an order based on the first priority and the second priority.

17. The electronic device of claim 16, wherein the first telecommunication network includes a sensor network.

18. The electronic device of claim 17, wherein the processor recognizes in the first message an indication of an emergency event at a sensor of the sensor network, assigns an emergency priority to the first message, and processes the first message on an emergency basis.

19. The electronic device of claim 18, further comprising:
a transmitter that transmits on the second communications network an emergency response based on the first message.

20. The electronic device of claim 16, wherein communication of the first communication network occurs between a channel envelop of the second communications network to reduce interference.
